(19) United States
(12) Patent Application Publication
(10) Pub. No.: US 2016/0149951 A1
(43) Pub. Date: May 26, 2016

(54) SECURE TRANSMISSION METHOD AND SYSTEM

(71) Applicant: ELECTRONICS AND TELECOMMUNICATIONS RESEARCH INSTITUTE, Daejeon (KR)

(72) Inventors: Taek Jun NAM, Daejeon (KR); Yong Ick CHUNG, Daejeon (KR); Taek Kyu LEE, Daejeon (KR); Myeongryeol CHOI, Daejeon (KR)

(21) Appl. No.: 14/878,483

(22) Filed: Oct. 8, 2015

(30) Foreign Application Priority Data
Nov. 21, 2014 (KR) 10-2014-0163337

(51) Int. Cl. H04L 29/06; H04B 7/14

(52) U.S. Cl. CPC H04L 63/1475; H04B 7/14

(57) ABSTRACT

A secure transmission method and system that can reduce the channel capacity of an eavesdropper even in an environment in which there is no direct path between a source and a destination. In the secure transmission method, all of a plurality of relays between a source and a destination receive a transmission signal including first artificial noise from the source, and decode the transmission signal. All the relays forward decoded signals to the destination. The source outputs second artificial noise while all the relays are forwarding the decoded signals to the destination. The second artificial noise is received only by an eavesdropper.

### CROSS REFERENCE TO RELATED APPLICATION

This application claims the benefit of Korean Patent Application No. 10-2014-0163337, filed Nov. 21, 2014, which is hereby incorporated by reference in its entirety into this application.

### BACKGROUND OF THE INVENTION

1. Technical Field

The present invention generally relates to a secure transmission method and system and, more particularly, to a method and system that protect user data in a wireless environment using all intermediate relays present between a source and a destination when there is no direct path between the source and the destination.

2. Description of the Related Art

Existing secure transmission techniques have been applied to the case where there are direct paths between a source and a destination and between the source and an eavesdropper. Of course, existing secure transmission techniques have also been applied to the case where not all direct paths between a source, a destination, and an eavesdropper are present, but where the source only has a path to a cooperative relay, through which the destination and the eavesdropper receive information.

For example, the paper “Joint Relay and Jammer Selection for Secure Two-way Relay Networks (ICC 2011, 1-5, 2011. Jingchao Chen, Rongqing Zhang, Lingyang Song, Zhu Han, Bingli Jiao)” (hereinafter referred to as “paper 1”) discloses a technique in which some cooperative relays transmit artificial noise or interference (jamming signal) when a source desires to transmit information using cooperative relays, in a method for delivering information.

Another paper “Joint Decode-and-forward and Jamming for Wireless Physical Layer Security with Destination Assistance (Asilomar 2011, 109-113, 2011.11. Yupeng Liu, Athina P. Petropulu, H. Vincent Poor)” (hereinafter referred to as “paper 2”) uses a scheme in which, in a first stage in which the source transmits information, the destination transmits artificial noise to reduce the channel capacity of an eavesdropper.

In existing secure transmission techniques, information can be considered to be transmitted in two stages.

In stage 1, the source transmits signal x, and a group for transmitting noise (e.g. some of the cooperative relays or the destination) transmits noise z.

In stage 2, some of the cooperative relays, which do not transmit noise, receive signal x from the source and perform a decode-and-forward operation on the signal x. At this time, a relay group, which transmits noise, does not transmit a signal.

The reception of signals in respective stages and the channel capacities at that time are described based on the above-cited paper 2. Further, all transmission/reception is assumed to be based on half-duplex communication. That is, signals are not simultaneously transmitted and received. Furthermore, the source and the cooperative relays are assumed to be aware of all of channel state information between individual links. In the existing paper 2, the source and the cooperative relays are assumed to be aware of even the channel state information of the eavesdropper. This assumption is generally made for physical layer security.

The respective signals received in each stage are as follows:

(Stage 1)

In stage 1, meaningful signals include signals received by cooperative relays and a signal received by the eavesdropper. Since half-duplex communication is assumed, the destination transmits noise in stage 1, and thus does not receive a signal.

In stage 1, signals transmitted from a source x_{1,S} and a destination x_{D} are given as follows:

x_{1,S}=\sqrt{P_{S}^{data}}u+\sqrt{P_{SD}^{jamming}}[W_{SD-E}]₁v₁

x_{D}=\sqrt{P_{SD}^{jamming}}[W_{SD-E}]₂v₁

where P_{S}^{data} denotes the power required by each cooperative relay to transmit data, u denotes the signal that is desired to be transmitted, P_{SD}^{jamming} denotes the power required to transmit artificial noise between the source and the destination, and v₁ denotes the noise signal in stage 1. Further, [W_{SD-E}] denotes a beamforming vector. The beamforming vector must be generated to be orthogonal to [h_{SR}, h_{DR}]. Here, the signals received by the cooperative relay and the eavesdropper are described as follows:

y_{Ri}=h_{SRi}x_{1,S}+h_{DRi}x_{D}+n_{Ri}

y_{E,1}=h_{SE}x_{1,S}+h_{DE}x_{D}+n_{E,1}

where h_{SRi} denotes the channel state information between the source and an i-th cooperative relay, h_{DRi} denotes the channel state information between the destination and the i-th cooperative relay, h_{SE} denotes the channel state information between the source and the eavesdropper, and h_{DE} denotes the channel state information between the destination and the eavesdropper. n_{Ri} denotes the additional noise of the i-th cooperative relay and n_{E,1} denotes the additional noise of the eavesdropper.

In paper 2, since signals are transmitted by selecting an optimal antenna, the i-th index in the above equation is meaningless. Further, when the above equation is arranged by substituting the transmitted signals into the equation, the respective signals received in each stage are represented by the following equation:

y_{R}=\sqrt{P_{S}^{data}}h_{SR}u+n_{R}

y_{E,1}=\sqrt{P_{S}^{data}}h_{SE}u+\sqrt{P_{SD}^{jamming}}(h_{SE}[W_{SD-E}]₁+h_{DE}[W_{SD-E}]₂)v₁+n_{E,1}

(Stage 2)

One of the cooperative relays that receive the signals in the above-described stage 1 is selected, and forwards a signal that is desired to be transmitted to the destination and an artificial noise signal using a decode-and-forward scheme. Simultaneously therewith, the destination transmits an artificial noise signal. In this case, the signals transmitted from the selected cooperative relay x_{R} and the source x_{2,S} are given as follows;

x_{2,S}=\sqrt{P_{SR}^{jamming}}[W_{SR-E}]₁v₂

x_{R}=\sqrt{P_{R}^{data}}u+\sqrt{P_{SR}^{jamming}}[w_{SR-E}]₂v₂

where P_{R}^{data} denotes the power required by the cooperative relay to forward data, P_{SR}^{jamming} denotes the power required to transmit artificial noise between the source and the cooperative relay, and u denotes the signal decoded in order for the selected cooperative relay to perform a decode-and-forward operation on the signal that is desired to be transmitted (as in the case of the other papers, it is assumed that complete decoding has been performed). v₂ denotes an artificial noise signal in stage 2. [W_{SR-E}] denotes a beamforming vector. The beamforming vector must be generated to be orthogonal to [h_{SD}, h_{RD}]. The signals received by the destination and the eavesdropper are given as follows.

y_{D}=h_{RD}x_{R}+h_{SD}x_{2,S}+n_{D}

y_{E}=h_{RE}x_{R}+h_{SE}x_{2,S}+n_{E,2}

where h_{RD} denotes the channel state information between the selected cooperative relay and the destination, h_{SD} denotes the channel state information between the source and the destination, h_{RE} denotes the channel state information between the selected cooperative relay and the eavesdropper, and h_{SE} denotes the channel state information between the source and the eavesdropper. n_{D} denotes the additional noise of the destination, and n_{E,2} denotes the additional noise of the eavesdropper.

Similar to the above-described case, when the above equation is arranged by substituting the transmitted signals into the equation, the following equation is given:

y_{D}=\sqrt{P_{R}^{data}}h_{RD}u+n_{D}

y_{E,2}=\sqrt{P_{R}^{data}}h_{RE}u+\sqrt{P_{SR}^{jamming}}(h_{RD}[W_{SR-E}]₂+h_{SE}[W_{SR-E}]₁)v₂+n_{E,2}

### SUMMARY OF THE INVENTION

Accordingly, the present invention has been made keeping in mind the above problems occurring in the prior art, and an object of the present invention is to provide a secure transmission method and system that can reduce the channel capacity of an eavesdropper even in an environment in which there is no direct path between a source and a destination.

In accordance with an aspect of the present invention to accomplish the above object, there is provided a secure transmission method, including receiving, by all of a plurality of relays between a source and a destination, a transmission signal including first artificial noise from the source; decoding, by all the relays, the received signal; forwarding, by all the relays, decoded signals to the destination; and outputting, by the source, second artificial noise while all the relays are forwarding the decoded signals to the destination.

Outputting the second artificial noise may be configured such that a weight vector is not included in the second artificial noise.

The second artificial noise may be received by an eavesdropper.

The transmission signal, received from the source and including the first artificial noise, may also be received by an eavesdropper.

The transmission signal, received from the source and including the first artificial noise, may further include a weight vector.

In accordance with another aspect of the present invention to accomplish the above object, there is provided a secure transmission system, including a source; and a plurality of relays installed between the source and a destination, wherein each of the relays decodes a transmission signal, received from the source and including first artificial noise, and forwards the decoded signal to the destination, and wherein the source outputs second artificial noise while all of the relays are forwarding the decoded signal to the destination.

The source may not include a weight vector in the second artificial noise upon outputting the second artificial noise.

In accordance with a further aspect of the present invention to accomplish the above object, there is provided a secure transmission method, the method being performed in a system in which a plurality of relays are installed between a source and a destination that are capable of transmitting and receiving signals through the relays, the secure transmission method including, as the source transmits a signal, receiving, by the relays and an eavesdropper, the signal; and outputting, by the source, artificial noise while each of the relays is decoding the signal and forwarding the signal to the destination, the artificial noise being received by the eavesdropper.

The artificial noise may not include a weight vector.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a wireless communication system to which a secure transmission method according to an embodiment of the present invention is applied;

FIG. 2 is a flowchart showing a secure transmission method according to an embodiment of the present invention;

FIGS. 3 and 4 are diagrams showing a channel gain model employed in the description of the secure transmission method according to an embodiment of the present invention; and

FIG. 5 is an internal configuration diagram showing a relay device according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here, including technical or scientific terms, have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

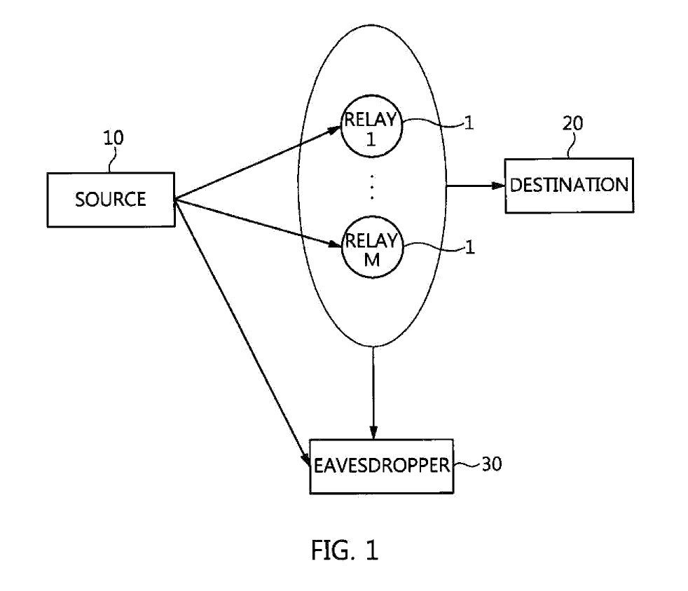

FIG. 1 is a configuration diagram showing a wireless communication system to which a secure transmission method according to an embodiment of the present invention is applied.

In FIG. 1, the wireless communication system includes a plurality of relays 1, a source 10, a destination 20, and an eavesdropper 30.

The relays 1 are present between the source 10 and the destination 20.

An environment in which there is no direct path between the source 10 and the destination 20 is assumed. In the environment in which there is no direct path, the destination 20 may receive a signal from the source 10 only through the relays 1, and cannot directly receive the signal from the source 10. Such an environment means that the destination 20 is present in a deep-fading environment. In such cases, with typical transmission schemes, the destination 20 cannot have channel capacity better than that of the eavesdropper 30. Accordingly, the present invention utilizes an artificial noise (jamming signal) transmission technique in order for the destination 20 to have better channel capacity than the eavesdropper 30 even in such an environment.

When the secure transmission method according to the embodiment of the present invention is inclusively considered, the secure transmission method includes a first stage in which the source 10 transmits a signal and artificial noise (i.e. first artificial noise) to the plurality of relays 1; and a second stage in which the plurality of relays 1 generate data to be forwarded from the signal received in the first stage and forward the data to the destination 20 by using a decode-and-forward technique.

In the first stage, the plurality of relays 1 and the eavesdropper 30 merely receive signals.

Subsequently, in the second stage, the source 10 and the plurality of relays 1 transmit signals, and the destination 20 and the eavesdropper 30 receive the signals. In the second stage, the relays forward the signal received in the first stage using a decode-and-forward technique at the same time that the source transmits separate artificial noise (i.e., second artificial noise).

In this way, the channel capacity of the eavesdropper 30 may be reduced below that of the destination 20. Unlike the structure disclosed in existing papers, in which only optimal relays are selected to forward signals and the remaining relays do not transmit any signals, the present invention uses all relays 1. Accordingly, the present invention may improve the channel capacity of the destination 20.

Further, since the present invention assumes an environment in which there is no direct path between the source 10 and the destination 20, the present invention may be designed to have a simple structure in which complicated beamforming is not used when artificial noise is transmitted from the source 10.

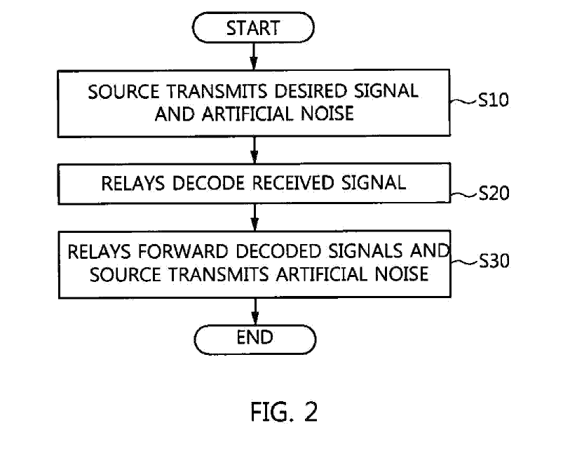

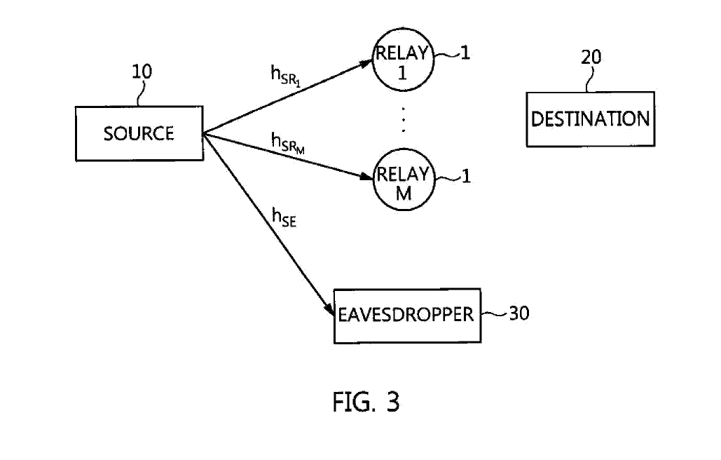

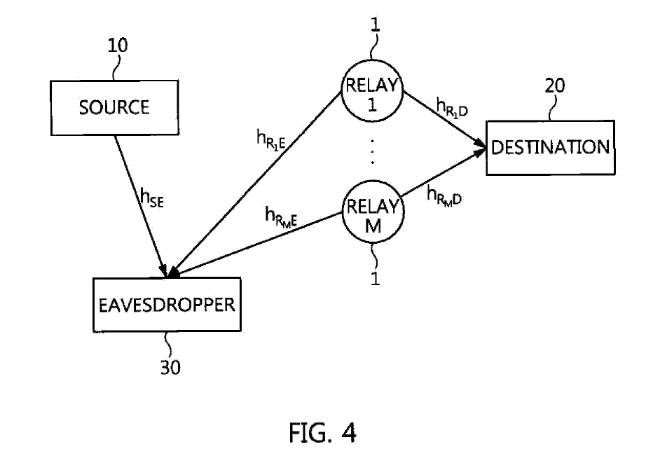

FIG. 2 is a flowchart showing a secure transmission method according to an embodiment of the present invention, and FIGS. 3 and 4 are diagrams showing the channel gain model employed in the description of the secure transmission method according to an embodiment of the present invention.

The present invention presents a secure transmission technique that uses a plurality of relays 1.

Each relay 1 forwards a signal using a decode-and-forward scheme. The relay forwards the signal via half-duplex communication. The power of all forwarded signals is assumed to be limited to P₀.

At the first step S10, the source 20 transmits a transmission signal x_{S}, which includes a signal desired to be transmitted and artificial noise, to the plurality of relays 1.

The transmission signal x_{S} from the source 10 may be represented by the following Equation (1):

x_{S}=\sqrt{P_{S}}(u+w_{S}^{H}z) (1)

where P_{S} denotes the power of the signal transmitted from the source 10, u denotes the signal to be transmitted, z denotes artificial noise, and w_{S}^{H} denotes a weight vector.

Since the artificial noise z is a signal transmitted to reduce the channel capacity of the eavesdropper 30, it must not influence the channel capacities of the relays. Therefore, in order for the plurality of relays to eliminate artificial noise, the source generates a weight vector that is orthogonal to pieces of channel state information between the source 10 and the relays 1, and then transmits the transmission signal.

Here, the signals received by the relays 1 and the eavesdropper 30 (see FIG. 3) are represented by the following Equations (2) and (3):

y_{R}=\sqrt{P_{S}}h_{SR}x_{S}+n_{R} (2)

where y_{R} denotes the signal received by each relay 1 and P_{S} denotes the power of the signal transmitted from the source 10. Further, h_{SR} denotes a channel state information vector between the source 10 and the relay 1, and n_{R} denotes additional noise received by the relay 1.

y_{E,1}=\sqrt{P_{S}}h_{SE}x_{S}+n_{E,1} (3)

where y_{E,1} denotes the signal received by the eavesdropper 30 at the first step, and P_{S} denotes the power of the signal transmitted from the source 10. Further, h_{SE} denotes the channel state information between the source 10 and the eavesdropper 30, and n_{E,1} denotes additional noise received by the eavesdropper 30 at the first step.

When Equations (1) and (2) are substituted into Equation (3), the following Equations (4) and (5) may result:

y_{R}=\sqrt{P_{S}}h_{SR}x+\sqrt{P_{S}}h_{SR}w_{S}^{H}z+n_{R} (4)

y_{E}=\sqrt{P_{S}}h_{SE}x_{S}+\sqrt{P_{S}}h_{SE}w_{S}^{H}z+n_{E,1} (5)

Meanwhile, when the weight vectors are selected so that h_{SR}w_{S}^{H}=0 is satisfied in Equation (4), Equation (4) may be expressed as the following Equation (6):

y_{R}=\sqrt{P_{S}}h_{SR}x+n_{R} (6)

At the second step S20, respective relays 1 decode the received signals. Here, it is assumed that the respective relays 1 have completely decoded the signal transmitted from the source 10, as given by the following Equation (7). This assumption is typically made in the case of a wireless communication system that uses the relays 1 for physical layer security.

û=u (7)

Thereafter, at the third step S30, the respective relays 1 forward the decoded signals to the destination 20, and the source 10 applies artificial noise to the outside of the source. In this case, artificial noise does not require a weight vector, unlike the first step S10. Therefore, a simple transmitter may be designed. Further, since an environment in which there is no direct path between the source 10 and the destination 20 has been assumed, the artificial noise from the source 10 at the third step S30 will be consequently received by the eavesdropper 30. Therefore, since the source 10 needs only to output artificial noise that can be received by the eavesdropper 30, a weight vector such as that in Equation (1) is not required. The artificial noise at the third step S30 may reduce the channel capacity of the eavesdropper 30. Meanwhile, the artificial noise at the third step S30 may correspond to second artificial noise described in the accompanying claims of the present invention.

Accordingly, the signal transmitted from the source 10 may be x_{S}=\sqrt{P_{S}^{jamming}}z and the signal forwarded from each relay 1 may be u_{R}=\sqrt{P_{R}^{data}}u.

In this way, the signal x_{S} (i.e. x_{S}=\sqrt{P_{S}^{jamming}}z) transmitted from the source 10 is received by the eavesdropper 30, and the signal u_{R} forwarded from the relay 1 is received by the destination 20.

Therefore, the signal received by the destination 20 is represented by the following Equation (8):

y_{D,2}=\sqrt{P_{R}^{data}}h_{RD}u+n_{D,2} (8)

where P_{R}^{data} denotes the power required by the relay 1 to forward data, h_{RD} denotes a channel state information vector between the relay 1 and the destination 20, u denotes a decoded signal, and n_{D,2} denotes the additional noise of the destination 20.

Further, the signal received by the eavesdropper 30 is represented by the following Equation (9):

y_{E,2}=\sqrt{P_{R}^{data}}h_{RE}u+\sqrt{P_{S}^{jamming}}h_{SE}z+n_{E,2} (9)

where P_{R}^{data} denotes the power required by the relay 1 to forward data, h_{RE} denotes a channel state information vector between the relay 1 and the eavesdropper 30, u denotes a decoded signal, P_{S}^{jamming} denotes the power required by the source 10 to transmit artificial noise, h_{SE} denotes the channel state information between the source 10 and the eavesdropper 30, z denotes artificial noise, and n_{E,2} denotes the additional noise of the eavesdropper 30.

As shown in Equations (8) and (9), the destination 20 receives the signal u, forwarded from each relay 1, and the additional noise n_{D,2}. In contrast, the eavesdropper 30 receives the artificial noise z transmitted from the source 10, as well as the signal, forwarded from the relay 1, and the additional noise n_{E,2}. Accordingly, it can be seen that the channel capacity of the eavesdropper 30 has been reduced below that of the destination 20.

As described above, the method of the present invention reduces the channel capacity of the eavesdropper 30 by allowing the source 10 to transmit artificial noise.

Technology in existing publications uses a scheme for reducing the channel capacity of the eavesdropper 30 without reducing the channel capacity of the destination 20, by using the relays 1 in the case where there is a direct path between the source 10 and the destination 20 or even between the eavesdropper 30 and the destination 20, as well as between the source 10 and the eavesdropper 30. In contrast, the present invention may reduce the channel capacity of the eavesdropper 30 even when it is assumed that the eavesdropper 30 may eavesdrop on the signal transmitted from the source 10, although there is no direct transmission path between the source 10 and the destination 20.

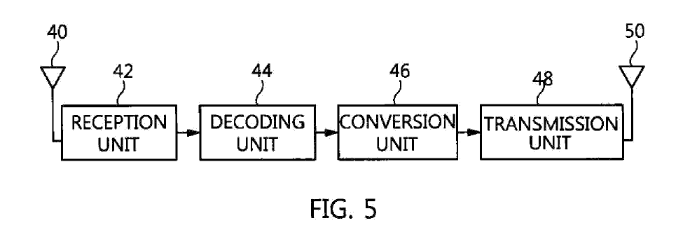

FIG. 5 is an internal configuration diagram showing a relay device according to an embodiment of the present invention.

The relay device according to the embodiment of the present invention includes a reception unit 42, a decoding unit 44, a conversion unit 46, and a transmission unit 48.

The reception unit 42 receives a transmission signal u and an artificial noise signal z from the source 10 through a receiving antenna 40. Here, the signal received by the reception unit 42 is given by Equation (2).

The decoding unit 44 decodes the signal received through the reception unit 42. Here, the decoding unit 44 is configured to completely decode the transmission signal u from the source 10.

The conversion unit 46 converts the signal decoded by the decoding unit 44 into a signal to be transmitted to the destination 20.

The transmission unit 48 controls the gain of the signal from the conversion unit 46, and then transmits the gain-controlled signal to the destination unit 20 through a transmitting antenna 50. Here, the signal transmitted to the destination 20 is represented by u_{R}=\sqrt{P_{R}^{data}}u.

Further, the reception unit 42 does not receive artificial noise from the source 10 while the transmission unit 48 is transmitting the signal to the destination 20.

In accordance with the present invention having the above configuration, there is an advantage in that a destination is in a deep-fading environment, so that the channel capacity of the destination may be increased above that of the eavesdropper using all relays between a source and the destination even in an environment in which there is no direct path between the source and the destination, thus realizing secure transmission in a physical layer.

The present invention uses a plurality of relays, thereby preventing any possibility that an eavesdropper may attack a selected relay.

In the present invention, a source transmits a signal and artificial noise in stage 1, and transmits artificial noise in stage 2, thus reducing the channel capacity of the eavesdropper.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A secure transmission method comprising:
receiving, by all of a plurality of relays between a source and a destination, a transmission signal including first artificial noise from the source;
decoding, by all the relays, the received signal;
forwarding, by all the relays, decoded signals to the destination; and
outputting, by the source, second artificial noise while all the relays are forwarding the decoded signals to the destination.

2. The secure transmission method of claim 1, wherein outputting the second artificial noise is configured such that a weight vector is not included in the second artificial noise.

3. The secure transmission method of claim 1, wherein the second artificial noise is received by an eavesdropper.

4. The secure transmission method of claim 1, wherein the transmission signal, received from the source and including the first artificial noise, is also received by an eavesdropper.

5. The secure transmission method of claim 1, wherein the transmission signal, received from the source and including the first artificial noise, further includes a weight vector.

6. A secure transmission system comprising:
a source; and
a plurality of relays installed between the source and a destination,
wherein each of the relays decodes a transmission signal, received from the source and including first artificial noise, and forwards the decoded signal to the destination, and
wherein the source outputs second artificial noise while all of the relays are forwarding the decoded signal to the destination.

7. The secure transmission system of claim 6, wherein the source does not include a weight vector in the second artificial noise upon outputting the second artificial noise.

8. The secure transmission system of claim 6, wherein the second artificial noise is received by an eavesdropper.

9. The secure transmission system of claim 6, wherein the transmission signal, received from the source and including the first artificial noise, is also received by an eavesdropper.

10. The secure transmission system of claim 6, wherein the transmission signal, received from the source and including the first artificial noise, further includes a weight vector.

11. A secure transmission method, the method being performed in a system in which a plurality of relays are installed between a source and a destination that are capable of transmitting and receiving signals through the relays, the secure transmission method comprising:
as the source transmits a signal, receiving, by the relays and an eavesdropper, the signal; and
outputting, by the source, artificial noise while each of the relays is decoding the signal and forwarding the signal to the destination, the artificial noise being received by the eavesdropper.

12. The secure transmission method of claim 11, wherein the artificial noise does not include a weight vector.
